(19) United States
(12) Patent Application Publication
(10) Pub. No.: US 2010/0191943 A1
(43) Pub. Date: Jul. 29, 2010

(54) COORDINATION BETWEEN A BRANCH-TARGET-BUFFER CIRCUIT AND AN INSTRUCTION CACHE

(75) Inventor: Moshe Bukris, Rishon Lezion (IL)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: AGERE SYSTEMS INC., Allentown, PA (US)

(21) Appl. No.: 12/359,761

(22) Filed: Jan. 26, 2009

(51) Int. Cl. G06F 9/38

(52) U.S. Cl. 712/238; 712/E09.045

(57) ABSTRACT

A digital signal processor (DSP) having (i) a processing pipeline for processing instructions received from an instruction cache (I-cache) and (ii) a branch-target-buffer (BTB) circuit for predicting branch-target instructions corresponding to received branch instructions. The DSP reduces the number of I-cache misses by coordinating its BTB and instruction pre-fetch functionalities. The coordination is achieved by tying together an update of branch-instruction information in the BTB circuit and a pre-fetch request directed at a branch-target instruction implicated in the update. In particular, if an update of the branch-instruction information is being performed, then, before the branch instruction implicated in the update reenters the processing pipeline, the DSP initiates a pre-fetch of the corresponding branch-target instruction.

### BACKGROUND OF THE INVENTION

1. Field of the Invention

The present invention relates to the field of microprocessor architecture and, more specifically, to pipelined microprocessors.

2. Description of the Related Art

This section introduces aspects that may help facilitate a better understanding of the invention(s). Accordingly, the statements of this section are to be read in this light and are not to be understood as admissions about what is in the prior art or what is not in the prior art.

A typical modern digital signal processor (DSP) uses pipelining to improve processing speed and efficiency. More specifically, pipelining divides the processing of each instruction into several logic steps or pipeline stages. In operation, at each clock cycle, the result of a preceding pipeline stage is passed onto the following pipeline stage, which enables the processor to process each instruction in as few clock cycles as there are pipeline stages. A pipelined processor is more efficient than a non-pipelined processor because different pipeline stages can work on different instructions at the same time. A representative pipeline might have four pipeline stages, such as fetch, decode, execute, and write. Some processors (often referred to as “deeply pipelined”) are designed to subdivide at least some of these pipeline stages into two or more sub-stages for an additional performance improvement.

One known problem with a pipelined processor is that a branch instruction can stall the pipeline. More specifically, a branch instruction is an instruction that can cause a jump in the program flow to a non-sequential program address. In a high-level programming language, a branch instruction usually corresponds to a conditional statement, a subroutine call, or a GOTO command. To appropriately process a branch instruction, the processor needs to decide whether a jump will in fact take place. However, the corresponding jump condition is not going to be fully resolved until the branch instruction reaches the “execute” stage near the end of the pipeline because the jump condition requires the pipeline to bring in application data. Until the resolution takes place, the “fetch” stage of the pipeline does not unambiguously “know” which instruction would be the proper one to fetch immediately after the branch instruction, thereby potentially causing an interruption in the timely flow of instructions through the pipeline.

### SUMMARY OF THE INVENTION

Problems in the prior art are addressed by various embodiments of a digital signal processor (DSP) having (i) a processing pipeline for processing instructions received from an instruction cache (I-cache) and (ii) a branch-target-buffer (BTB) circuit for predicting branch-target instructions corresponding to received branch instructions. The DSP reduces the number of I-cache misses by coordinating its BTB and instruction pre-fetch functionalities. The coordination is achieved by tying together an update of branch-instruction information in the BTB circuit and a pre-fetch request directed at a branch-target instruction implicated in the update. In particular, if an update of the branch-instruction information is being performed, then, before the branch instruction implicated in the update reenters the processing pipeline, the DSP initiates a pre-fetch of the corresponding branch-target instruction. In one embodiment, the DSP core incorporates a coordination module that configures the processing pipeline to request the pre-fetch each time branch-instruction information in the BTB circuit is updated. In another embodiment, the BTB circuit applies a touch signal to the I-cache to cause the I-cache to perform the pre-fetch without any intervention from other circuits in the DSP core.

According to one embodiment, the present invention is a processor having: (1) a processing pipeline adapted to process a stream of instructions received from an I-cache; and (2) a BTB circuit operatively coupled to the processing pipeline and adapted to predict an outcome of a branch instruction received via said stream. The processor is adapted to: (i) perform an update of branch-instruction information in the BTB circuit based on processing the branch instruction in the processing pipeline; and (ii) initiate a pre-fetch into the I-cache of a branch-target instruction corresponding to the branch instruction implicated in the update before a next entrance of the branch instruction into the processing pipeline.

According to another embodiment, the present invention is a processing method having the steps of: (A) processing a stream of instructions received from an I-cache by moving each instruction through stages of a processing pipeline; (B) predicting an outcome of a branch instruction received via said stream using a BTB circuit operatively coupled to the processing pipeline; (C) performing an update of branch-instruction information in the BTB circuit based on processing the branch instruction in the processing pipeline; and (D) initiating a pre-fetch into the I-cache of a branch-target instruction corresponding to the branch instruction implicated in the update before a next entrance of the branch instruction into the processing pipeline.

### BRIEF DESCRIPTION OF THE DRAWINGS

Other aspects, features, and benefits of the present invention will become more fully apparent from the following detailed description, the appended claims, and the accompanying drawings in which:

FIG. 1 shows a block diagram of a digital signal processor (DSP) according to one embodiment of the invention;

FIG. 2 shows a block diagram of a branch-target-buffer (BTB) circuit that can be used in the DSP of FIG. 1 according to one embodiment of the invention; and

FIG. 3 shows a block diagram of a DSP according to another embodiment of the invention.

### DETAILED DESCRIPTION

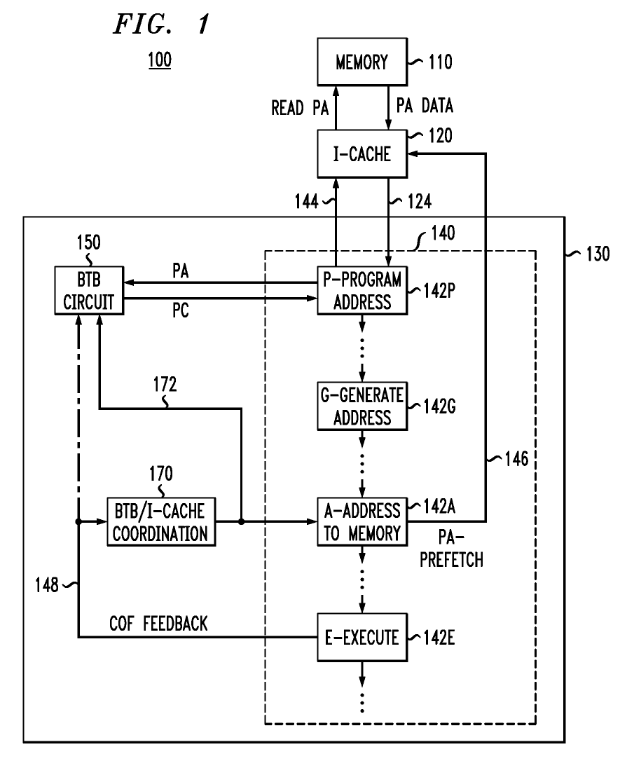

FIG. 1 shows a block diagram of a digital signal processor (DSP) 100 according to one embodiment of the invention. DSP 100 has a core 130 operatively coupled to an instruction cache (I-cache) 120 and a memory 110. In one embodiment, I-cache 120 is a level-I cache located on-chip together with DSP core 130, while memory 110 is a main memory located off-chip. In another embodiment, memory 110 is a main memory located on chip.

DSP core 130 has a processing pipeline 140 comprising a plurality of pipeline stages. In a one embodiment, processing pipeline 140 includes the following representative stages: (1) a fetch-and-decode stage; (2) a group stage; (3) a dispatch stage; (4) an address-generation stage; (5) a first memory-read stage; (6) a second memory-read stage; (7) an execute stage; and (8) a write stage. Note that FIG. 1 explicitly shows only four pipeline sub-stages 142 that are relevant to the description of DSP 100 below. More specifically, pipeline sub-stages 142P, 142G, and 142A belong to the fetch-and-decode stage, and pipeline sub-stage 142E belongs to the execution stage. All other stages and sub-stages of processing pipeline 140 are omitted in FIG. 1 for clarity.

In an alternative embodiment, processing pipeline 140 can be designed to have (i) a different composition of stages and/or sub-stages and/or (ii) a different breakdown of stages into sub-stages. One skilled in the art will appreciate that various embodiments of a coordination function for a branch-target-buffer circuit and an instruction cache that are described in more detail below can be interfaced and work well with different embodiments of processing pipeline 140. The brief description of the above-enumerated eight pipeline stages that is given below is intended as an illustration only and is not to be construed as limiting the composition of processing pipeline 140 to these particular stages.

The fetch-and-decode stage fetches instructions from I-cache 120 and/or memory 110 and decodes them. As used herein, the term “decoding” means determining what type of instruction is received and breaking it down into one or more micro-operations with associated micro-operands. The one or more micro-operations corresponding to an instruction perform the function of that instruction in a manner appropriate for a particular hardware implementation of DSP core 130.

The group stage checks grouping and dependency rules and groups valid interdependent micro-operations together.

The dispatch stage (i) reads operands for the generation of addresses and for the update of control registers and (ii) dispatches valid instructions to all relevant functional units of DSP core 130.

The address-generation stage calculates addresses for the “loads” and “stores” and, when appropriate, a change-of-flow address or addresses. As used herein, the term “loading” refers to the processes of (i) retrieving, from the data cache (not explicitly shown in FIG. 1) and/or memory 110, the application data that serve as operands for an instruction and (ii) saving the retrieved data in the registers. Similarly, the term “storing” refers to the process of transferring application data back to the data cache and/or memory 110.

The first memory-read stage uses the calculated addresses to send a request for application data to the data cache and/or memory 110.

The second memory-read stage loads the requested data from the data cache and/or memory 110 into appropriate registers.

The execute stage executes micro-operations on the corresponding operand loads.

The write stage writes the results of the execute stage into the registers and, if appropriate, transfers these results to the data cache and/or memory 110.

Pipeline sub-stage 142P functions to continually fetch program instructions (also known as macro instructions) from I-cache 120 and/or memory 110 to DSP core 130. More specifically, pipeline sub-stage 142P requests a next program instruction from I-cache 120 using a read-request signal 144, in which said instruction is identified by an instruction pointer or program address (PA). The request can produce an I-cache hit or an I-cache miss. An I-cache hit occurs if the requested instruction is found in the I-cache. An I-cache miss occurs if the requested instruction is not found in the I-cache. An instruction corresponding to an I-cache hit can be immediately loaded, via an instruction load signal 124, into an appropriate register within pipeline 140, and the corresponding processing can proceed without delay. In contrast, an instruction corresponding to an I-cache miss has to be retrieved from memory 110, which stalls pipeline 140 at least for the time needed for said retrieval. This stall is typically referred to as an I-cache-miss penalty.

Branch instructions within the instruction stream prevent pipeline sub-stage 142P from being able to fetch instructions along a sequential or predefined PA path. To help pipeline sub-stage 142P fetch correct instructions into pipeline 140, DSP core 130 incorporates a branch-target-buffer (BTB) circuit 150. More specifically, BTB circuit 150 is designed to dynamically predict branch instructions and their likely outcome. When a next instruction is fetched in by pipeline sub-stage 142P, the pipeline sub-stage provides the instruction's PA to BTB circuit 150 and requests branch-prediction information, if any, corresponding to that PA. If, based on the PA, BTB circuit 150 identifies the fetched instruction as a valid branch instruction, then the BTB circuit predicts whether the corresponding branch is going to be taken and returns to pipeline sub-stage 142P a program counter (PC) value corresponding to a predicted branch-target instruction of that branch instruction. As used herein, the term “branch-target instruction” refers to an instruction that immediately follows the branch instruction according to the proper flow of the program if the branch is taken. Based on the received PC value, pipeline sub-stage 142P can fetch a next instruction from an appropriate non-sequential PA, which reduces the probability of incurring a change-of-flow (COF) penalty. As used herein, the term “COF penalty” refers to a stall of pipeline 140 caused by the speculative processing of instructions from an incorrect PA path corresponding to a branch instruction and the subsequent flushing of the pipeline sub-stages loaded with instructions from that incorrect PA path. If BTB circuit 150 is unable to identify the fetched instruction as a valid branch instruction, then the BTB circuit generates, for pipeline sub-stage 142P, a PC response that is flagged as invalid. Pipeline sub-stage 142P typically disregards invalid responses and continues to fetch instructions along a sequential PA path.

Pipeline sub-stage 142G functions, inter alia, to generate the address for a COF operation.

Pipeline sub-stage 142A functions, inter alia, to reduce the number of I-cache-miss penalties by configuring I-cache 120 to pre-fetch, from memory 110, instructions that pipeline sub-stage 142P is likely to request in the near future. Normally, pipeline sub-stage 142A configures I-cache 120, via a pre-fetch-request signal 146, to pre-fetch instructions from a sequential PA path. However, if a branch instruction is anticipated, then pipeline sub-stage 142A uses pre-fetch-request signal 146 to configure I-cache 120 to pre-fetch the predicted branch-target instruction having a non-sequential PA. Pipeline sub-stage 142A can configure I-cache 120 to pre-fetch the predicted branch-target instruction alone or together with one or more instructions from the sequential PA path corresponding to the branch instruction and/or from the sequential PA path corresponding to the branch-target instruction. In one embodiment, the branch-target pre-fetch is coordinated with an update of BTB circuit 150 as described in more detail below in reference to the BTB/I-cache coordination module 170. After I-cache 120 executes the branch-target pre-fetch, there is a higher probability that the I-cache has a proper branch-target instruction prior to it being requested by pipeline sub-stage 142P. As a result, the number of I-cache-miss penalties can advantageously be reduced.

Pipeline sub-stage 142E functions, inter alia, to determine the final branch-decision outcome and the final branch-target address for each micro-operation corresponding to a branch instruction. For example, pipeline sub-stage 142E might execute the micro-operations corresponding to a branch instruction using the relevant application data loaded into the registers during the second memory-read stage (not explicitly shown in FIG. 1). Based on the results of the executed micro-operations, pipeline sub-stage 142E resolves the branch condition and provides the branch-resolution information to BTB circuit 150 via a COF feedback signal 148. BTB circuit 150 then uses the received branch-resolution information to update an existing entry in its branch-target buffer (BT buffer, not explicitly shown in FIG. 1) or to generate in the BT buffer a new entry specifying a new branch-target PA. Alternatively, pipeline sub-stage 142E might relay to BTB circuit 150 the results of COF processing performed by one or more preceding pipeline sub-stages (not explicitly shown in FIG. 1).

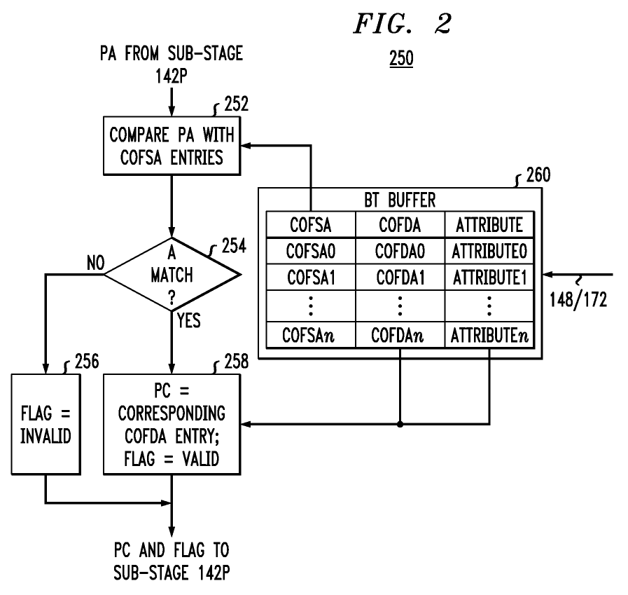

FIG. 2 shows a block diagram of BTB circuit 250 that can be used as BTB circuit 150 according to one embodiment of the invention. BTB circuit 250 has a branch-target (BT) buffer 260 that is used to identify branch instructions within an instruction stream and to predict the outcome of those branch instructions. More specifically, BT buffer 260 contains information about branch instructions that DSP core 130 has previously executed or loaded. The information is organized in three fields: (1) the COFSA field, which contains the PAs of valid branch instructions, with the acronym “COFSA” standing for “change-of-flow source address”; (2) the COFDA field, which contains program addresses of the branch-target instructions corresponding to the branch instructions identified in the COFSA field, with the acronym “COFDA” standing for “change-of-flow destination address”; and (3) the attribute field, which contains additional relevant information about the branch instructions. In one implementation, an attribute-field entry can (i) identify the type of the corresponding branch instruction, e.g., whether it is a conditional branch, a return from a subroutine, a subroutine call, or an unconditional branch, (ii) contain branch instruction's history, and/or (iii) specify the corresponding pattern of taking or not taking the branch. As already indicated above, BT buffer 260 updates an existing entry or generates a new entry based on COF feedback signal 148 received from pipeline sub-stage 142E. In one embodiment, BT buffer 260 has a capacity to hold information corresponding to up to n=512 branch instructions.

BTB circuit 250 processes a PA received from pipeline sub-stage 142P as indicated by processing blocks 252-258. More specifically, processing block 252 searches the COFSA entries of BT buffer 260 to determine whether any of them matches the received PA. If a match is not found, then processing block 254 directs further processing to processing block 256. If a match is found, then processing block 254 directs further processing to processing block 258.

Processing block 256 flags the PC output of BTB circuit 250 as invalid. As already indicated above, when pipeline sub-stage 142P detects a PC signal flagged as invalid, it disregards the PC signal and continues to fetch instructions from a sequential PA path.

Processing block 258 uses the entries from the COFDA and attribute fields of BT buffer 260 to predict the branch-target instruction corresponding to the received PA. Processing block 258 flags the PC output of BTB circuit 250 as valid and outputs thereon the PC value corresponding to the predicted branch-target instruction.

Referring back to FIG. 1, it is evident from the above description that both BTB circuit 150 and the pre-fetch mechanism implemented by pipeline sub-stage 142A function to reduce the total stall time of pipeline 140. More specifically, BTB circuit 150 reduces the probability of incurring a COF penalty, while the pre-fetch mechanism of pipeline sub-stage 142A reduces the number of I-cache misses. However, disadvantageously, a typical prior-art DSP does not coordinate its BTB and pre-fetch functionalities.

As an example, consider a situation in which BTB circuit 150 correctly predicts a branch-target instruction for pipeline sub-stage 142P, but I-cache 120 has not yet pre-fetched that branch-target instruction from memory 110. This situation can arise, for example, when BT buffer 260 (FIG. 2) has recently been updated based on COF feedback signal 148. When the branch instruction corresponding to the update enters pipeline 140, the processing of that instruction has to progress down to pipeline sub-stage 142A for the COF-address-send functionality to request the upcoming branch-target instruction for I-cache 120. However, based on the PC output of BTB circuit 150, pipeline sub-stage 142P will already request the branch-target instruction in the next clock cycle (i.e., the clock cycle that immediately follows the clock cycle in which the corresponding branch instruction has been processed by pipeline sub-stage 142P), i.e., before pipeline sub-stage 142A has a chance to initiate a COF-address send corresponding to the branch-target instruction. Unless the branch-target instruction had been fortuitously pre-fetched previously, this request will result in an I-cache miss. Consequently, an I-cache-miss penalty will be incurred despite the fact that the corresponding COF penalty has been avoided.

To address the above-indicated problem, DSP core 130 incorporates a BTB/I-cache coordination module 170 that enables the DSP core to initiate a pre-fetch into I-cache 120 of a branch-target instruction implicated in a BTB update before the corresponding branch instruction reenters pipeline 140. Coordination module 170 can be implemented using an appropriate modification of the instruction-set architecture (ISA) or by way of configuration of DSP core 130. In operation, coordination module 170 causes pipeline sub-stage 142A to request a pre-fetch into I-cache 120 of a branch-target instruction each time COF feedback signal 148 causes an update of the corresponding BTB entry in BTB circuit 150. Since the pre-fetch is requested prior to the point in time at which the branch instruction reenters pipeline 140 (not after that point, as it would be in a typical prior-art DSP), I-cache 120 is more likely to have enough time for completing the transfer of the corresponding branch-target instruction from memory 110 before that branch-target instruction is actually requested by pipeline sub-stage 142P. As a result, DSP 100 can advantageously avoid incurring both a COF penalty and an I-cache-miss penalty.

In one embodiment, DSP core 130 employs an ISA that enables a single ISA set to initiate both a BTB update and an I-cache pre-fetch, as indicated by signals 172 and 146 in FIG. 1. Note that, in a prior-art DSP, one ISA set is used to initiate a BTB update and a different ISA set is used to initiate an I-cache pre-fetch corresponding to the BTB update, wherein a substantial amount of time lapses between these two ISA sets. Thus, advantageously over the prior art, embodiments of DSP 100 can reduce the number ISA sets issued in relation to the BTB and pre-fetch functionalities during operation of DSP core 130, thereby freeing its resources for other functions.

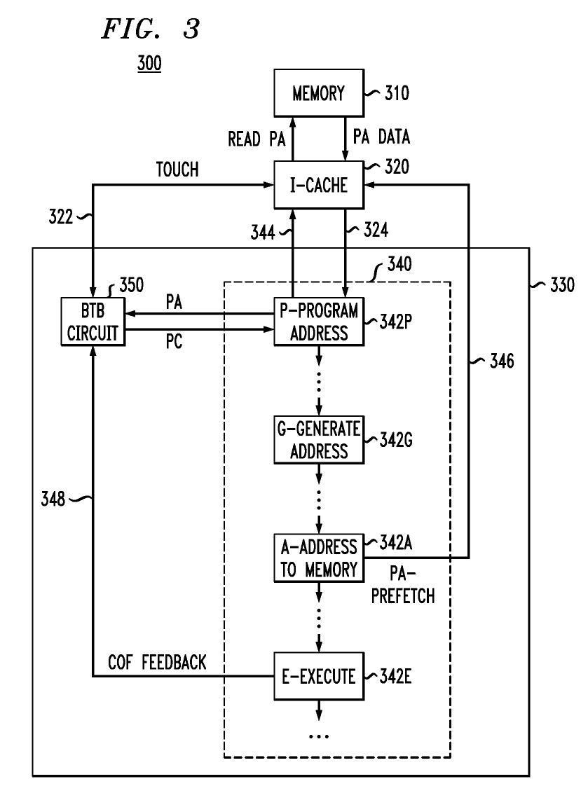

FIG. 3 shows a block diagram of a DSP 300 according to another embodiment of the invention. DSP 300 is generally analogous to DSP 100, and analogous elements of the two DSPs are designated with labels having the same last two digits. However, one difference between DSPs 100 and 300 is that they employ different BTB/I-cache coordination mechanisms. In particular, BTB circuit 350 of DSP 300 is designed to be able to send a pre-fetch signal 322 directly to I-cache 320, without intervention from other circuits (e.g., pipeline 340) of DSP core 330. In one implementation, pre-fetch signal 322 is a cache-touch instruction for I-cache 320 that is transmitted each time COF feedback signal 348 causes an update of the BT buffer in BTB circuit 350. As known in the art, a cache-touch instruction is a special instruction that serves as a signal to the memory controller to pre-fetch the specified information from the main memory to the cache memory. In the case of BTB circuit 350, a cache-touch instruction specifies the content(s) of the COFDA field (see FIG. 2) of an updated entry or of a new (i.e., most-recently created) entry in the BT buffer. Based on the cache-touch instruction, I-cache 320 proceeds to pre-fetch an instruction having the specified PA from main memory 310, thereby obtaining the requisite branch-target instruction for an upcoming request from pipeline sub-stage 342P. In one embodiment, pre-fetch signal 322 and pre-fetch-request signal 346 can be delivered to I-cache 320 on a common physical bus.

While this invention has been described with reference to illustrative embodiments, this description is not intended to be construed in a limiting sense. For example, a DSP that combines in an appropriate manner some or all of the BTB/I-cache coordination features of DSPs 100 and 300 is contemplated. Although DSPs 100 and 300 have been described in reference to BTB circuit 250 (FIG. 2), they can similarly employ other suitable BTB circuits. Representative examples of such BTB circuits can be found, e.g., in U.S. Pat. Nos. 5,867,698, 5,944,817, 6,948,054, 6,957,327, and 7,107,437, all of which are incorporated herein by reference in their entirety. One of ordinary skill in the art will appreciate that various embodiments of the invention can be practiced with a processing pipeline that differs from each of pipelines 140 and 340 in at least one of: the total number of pipeline stages; the breakdown of one or more pipeline stages into pipeline sub-stages; and the allocation of the pre-fetch functionality to a particular pipeline stage or sub-stage. Various modifications of the described embodiments, as well as other embodiments of the invention, which are apparent to persons skilled in the art to which the invention pertains are deemed to lie within the principle and scope of the invention as expressed in the following claims.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used in the claims, the term “update of branch-instruction information” should be construed as encompassing a change of an already-existing entry and the generation of a new entry in the BTB circuit.

What is claimed is:

1. A processor, comprising:
a processing pipeline adapted to process a stream of instructions received from an instruction cache (I-cache); and
a branch-target-buffer (BTB) circuit operatively coupled to the processing pipeline and adapted to predict an outcome of a branch instruction received via said stream, wherein the processor is adapted to:
perform an update of branch-instruction information in the BTB circuit based on processing the branch instruction in the processing pipeline; and
initiate a pre-fetch into the I-cache of a branch-target instruction corresponding to the branch instruction implicated in the update before a next entrance of the branch instruction into the processing pipeline.

2. The invention of claim 1, wherein the next entrance is an entrance that immediately follows an entrance corresponding to the update.

3. The invention of claim 1, further comprising a coordination module, wherein, if the update is initiated, then the coordination module configures the processing pipeline to request the pre-fetch.

4. The invention of claim 3, wherein the coordination module employs a single instruction-set-architecture (ISA) set to initiate both the update and the pre-fetch.

5. The invention of claim 1, wherein the BTB circuit is adapted to apply a touch signal to the I-cache to cause the I-cache to pre-fetch the branch-target instruction.

6. The invention of claim 5, wherein:
the processing pipeline is adapted to cause the update by applying to the BTB circuit a feedback signal based on the processing of the branch instruction; and
the update causes the BTB circuit to apply the touch signal to the I-cache.

7. The invention of claim 5, wherein the touch signal specifies a program address from a branch-target-instruction field of a most-recently updated branch-instruction-information entry in the BTB circuit.

8. The invention of claim 5, wherein:
the processing pipeline is adapted to request a pre-fetch into the I-cache of one or more instructions from a sequential program-address path having the branch instruction; and
the touch signal and said pre-fetch request are transmitted to the I-cache on a common physical bus.

9. The invention of claim 1, wherein:
the BTB circuit comprises a branch-target (BT) buffer; and
each entry in the BT buffer corresponding to a valid branch instruction contains a program address of that branch instruction and a program address of a corresponding branch-target instruction.

10. The invention of claim 9, wherein the BTB circuit is adapted to:
receive from the processing pipeline a program address of an instruction that has entered the processing pipeline in said stream; and
search the BTB entries to determine whether said entered instruction is a valid branch instruction, wherein, if the BTB circuit determines that said entered instruction is a valid branch instruction, then:
the BTB circuit returns to the pipeline the program address of the corresponding branch-target instruction from the BT buffer; and
the pipeline specifies the returned program address in a read request submitted to the I-cache.

11. The invention of claim 1, further comprising the I-cache, wherein the processing pipeline, the BTB circuit, and the I-cache are implemented in a single integrated circuit.

12. A processing method, comprising:
processing a stream of instructions received from an instruction cache (I-cache) by moving each instruction through stages of a processing pipeline;
predicting an outcome of a branch instruction received via said stream using a branch-target-buffer (BTB) circuit operatively coupled to the processing pipeline;
performing an update of branch-instruction information in the BTB circuit based on processing the branch instruction in the processing pipeline; and
initiating a pre-fetch into the I-cache of a branch-target instruction corresponding to the branch instruction implicated in the update before a next entrance of the branch instruction into the processing pipeline.

13. The invention of claim 12, wherein:
the step of performing comprises initiating the update; and
if the update is initiated, then the step of initiating the pre-fetch comprises configuring the processing pipeline to request the pre-fetch.

14. The invention of claim 13, wherein the steps of initiating the update and initiating the pre-fetch employ a single instruction-set-architecture (ISA) set to accomplish both of said initiating steps.

15. The invention of claim 12, wherein the step of initiating comprises applying to the I-cache a touch signal generated by the BTB circuit to cause the I-cache to pre-fetch the branch-target instruction.

16. The invention of claim 15, wherein:
the step of performing comprises applying to the BTB circuit a feedback signal generated by the processing pipeline based on the processing of the branch instruction; and
the update causes the BTB circuit to apply the touch signal to the I-cache.

17. The invention of claim 15, wherein the touch signal specifies a program address from a branch-target-instruction field of a most-recently updated branch-instruction-information entry in the BTB circuit.

18. The invention of claim 15, wherein:
the processing pipeline requests a pre-fetch into the I-cache of one or more instructions from a sequential program-address path having the branch instruction; and
the touch signal and said request are transmitted to the I-cache on a common physical bus.

19. The invention of claim 12, wherein:
the BTB circuit comprises a branch-target (BT) buffer; and
each entry in the BT buffer corresponding to a valid branch instruction contains a program address of that branch instruction and a program address of a corresponding branch-target instruction.

20. The invention of claim 19, further comprising the steps of:
directing from the processing pipeline to the BTB circuit a program address of an instruction that has entered the processing pipeline in said stream; and
searching the BTB entries to determine whether said entered instruction is a valid branch instruction; wherein, if the BTB circuit determines that said entered instruction is a valid branch instruction, then the method further comprises:
returning from the BTB circuit to the pipeline the program address of the corresponding branch-target instruction from the BT buffer; and
submitting from the pipeline to the I-cache a read request specifying the returned program address.
